(19) United States
(12) Patent Application Publication
(10) Pub. No.: US 2015/0212042 A1
(43) Pub. Date: Jul. 30, 2015

(54) IN-SITU ELECTROCHEMICAL DEPOSITION AND X-RAY FLUORESCENCE SPECTROSCOPY

(71) Applicant: Element Six Technologies Limited, Oxford (GB)

(72) Inventors: Mark Edward Newton, Warwickshire (GB); Julie Victoria MacPherson, Warwickshire (GB); Timothy Peter Mollart, Berkshire (GB)

(21) Appl. No.: 14/419,449

(22) PCT Filed: Aug. 9, 2013
(86) PCT No.: PCT/EP2013/066755

§ 371 Date: Feb. 3, 2015

Related U.S. Application Data
(60) Provisional application No. 61/683,035, filed on Aug. 14, 2012.

(30) Foreign Application Priority Data
Aug. 14, 2012 (GB) 1214451.5

(51) Int. Cl. G01N 27/42; G01N 27/27; G01N 27/38; G01N 23/223; G01N 27/30

(52) U.S. Cl. CPC G01N 27/42; G01N 23/223; G01N 27/308; G01N 27/305; G01N 27/38; G01N 27/27

(57) ABSTRACT

A sensor comprising: a first electrode formed of an electrically conductive material and configured to be located in contact which a solution to be analysed; a second electrode configured to be in electrical contact with the solution to be analysed; an electrical controller configured to apply a potential difference between the first and second electrodes to electro-deposit chemical species from the solution onto the first electrode, and an x-ray fluorescence spectrometer configured to perform an x-ray fluorescence spectroscopic analysis technique on the electro-deposited chemical species, the x-ray fluorescence spectrometer comprising an x-ray source configured to direct an x-ray excitation beam to the electro-deposited chemical species on the first electrode and an x-ray detector configured to receive x-rays emitted from the electro-deposited chemical species and generate spectroscopic data about the chemical species electro-deposited on the first electrode, wherein the sensor is configured such that in use the x-ray excitation beam incident on the electro-deposited chemical species on the first electrode is attenuated by no more than 60%.

### FIELD OF INVENTION

Certain embodiments of the present invention relate to the analysis of chemical species in solution using an in-situ electrochemical deposition and x-ray fluorescence spectroscopy technique. Certain embodiments are configured to also utilize electrochemical stripping voltammetry in combination with x-ray fluorescence spectroscopy. Certain embodiments utilize an electrically conductive diamond electrode for the in-situ electrochemical deposition and x-ray fluorescence spectroscopy technique.

### BACKGROUND OF INVENTION

Electrochemical sensors are well known. It has also been proposed in the prior art to provide a diamond based electrochemical sensor. Diamond can be doped with boron to form semi-conductive or metallic conductive material for use as an electrode. Diamond is also hard, inert, and has a very wide potential window making it a very desirable material for use as a sensing electrode for an electrochemical cell, particularly in harsh chemical, physical, and/or thermal environments which would degrade standard metal based electrochemical sensors. In addition, it is known that the surface of a boron doped diamond electrode may be functionalized to sense certain species in a solution adjacent the electrode.

One problem with using diamond in such applications is that diamond material is inherently difficult to manufacture and form into suitable geometries for sophisticated electrochemical analysis. To date, diamond electrodes utilized as sensing electrodes in an electrochemical cell have tended to be reasonably simple in construction and mostly comprise the use of a single piece of boron doped diamond configured to sense one physical parameter or chemical species at any one time. More complex arrangements have involved introducing one or more channels into a piece of boron doped diamond through which a solution can flow for performing electrochemical analysis. However, due to the inherent difficulties involved in manufacturing and forming diamond into multi-structural components, even apparently relatively simple target structures can represent a significant technical challenge.

In terms of prior art arrangements, WO 2005012894 describes a microelectrode comprising a diamond layer formed from electrically non-conducting diamond and containing one or more pin-like projections of electrically conducting diamond extending at least partially through the layer of non-conducting diamond and presenting areas of electrically conducting diamond at a front sensing surface. In contrast, WO2007107844 describes a microelectrode array comprising a body of diamond material including alternating layers of electrically conducting and electrically non-conducting diamond material and passages extending through the body of diamond material. In use, fluid flows through the passages and the electrically conducting layers present ring-shaped electrode surfaces within the passages in the body of diamond material.

More recently, it has been proposed that high aspect ratio boron doped diamond electrodes have improved sensing capability when compared with other boron doped diamond electrode arrangements. That is, it has been found to be highly advantageous to provide boron doped diamond electrodes which have a high length/width ratio at a sensing surface. Furthermore, it has been found that an array of high aspect ratio boron doped diamond electrodes providing a band sensor structure can be utilized to provide multiple sensing functions.

The previously described arrangements may comprise optically opaque, electrically conductive boron doped diamond electrodes spaced apart by optically transparent, non-conductive intrinsic diamond layers. The optically opaque, electrically conductive boron doped diamond electrodes can be driven to perform electrochemical measurements of species in aqueous solution. It has also been suggested that electrochemical techniques can also be combined with optical techniques such as spectroscopic measurements by using the non-conductive intrinsic diamond layers as an optical window as described in WO2007/107844. As such, electrochemical measurements can be performed at the optically opaque, electrically conductive boron doped diamond electrodes and optical measurements of the solution can be performed through non-conductive intrinsic diamond layers.

Swain et al. describe a combined electrochemistry-transmission spectroscopy technique for analysing chemical species in solution. The technique uses an electrochemical cell comprising an optically transparent carbon electrode (e.g. a thin film of boron-doped diamond on an optically transparent substrate), a thin solution layer, and an optical window mounted opposite the optically transparent carbon electrode such that transmission spectroscopy can be performed on species within the solution. The optically transparent carbon electrode is used to oxidize and reduce species in the solution. In situ IR and UV-visible spectroscopy is performed through the optically transparent carbon electrode to analyse dissolved species in the solution. Dissolved species which have different IR and UV-visible spectra in different oxidation states can be analysed. Although boron-doped diamond material is opaque at high boron concentrations, at least in the near infrared, visible, and UV regions of the electromagnetic spectrum due to a high absorption coefficient in these regions, thin films of such material have a reasonable optical transparency. It is described that the ability to cross-correlate electrochemical and optical data may provide new insights into the mechanistic aspects of a wide variety of electrochemical phenomena including structure-function relationships of redox-active proteins and enzymes, studies of molecular absorption processes, and as a dual signal transduction method for chemical and biological sensing [see “Measurements: Optically Transparent Carbon Electrodes” Analytical Chemistry, 15-22, 1 Jan. 2008, “Optically Transparent Diamond Electrode for Use in IR Transmission Spectroelectrochemical Measurements” Analytical Chemistry, vol. 79, no. 19, Oct. 1, 2007, “Spectroelectrochemical responsiveness of a freestanding, boron-doped diamond, optically transparent electrode towards ferrocene” Analytica Chimica Acta 500, 137-144 (2003), and “Optical and Electrochemical Properties of Optically Transparent, Boron-Doped Diamond Thin Films Deposited on Quartz” Analytical Chemistry, vol. 74, no. 23, 1 Dec. 2002]. Zhang et al. have also reported the use of an optically transparent boron-doped diamond thin film electrode for performing combined electrochemistry-transmission spectroscopy analysis [see “A novel boron-doped diamond-ciated platinum mesh electrode for spectroelectrochemistry” Journal of Electroanalytical Chemistry 603. 135-141 (2007)].

As an alternative to analysing chemical species while in solution as described above, one useful electro-chemical analysis technique involves applying a suitable voltage to a sensing electrode to electro-deposit chemical species out of solution onto the sensing electrode and then change the voltage to strip the species from the electrode. Different species strip from the electrode at different voltages. Measurement of electric current during stripping generates a series of peaks associated with different species stripping from the sensing electrode at different voltages. Such a stripping voltammetry technique can be used to analyse heavy metal content.

The use of a boron-doped diamond sensor in a stripping voltammetry technique has been described in U.S. Pat. No. 7,883,617B2 (University of Keio). Jones and Compton also describe the use of a boron-doped diamond sensor in stripping voltammetry techniques [see “Stripping Analysis using Boron-Doped Diamond Electrodes” Current Analytical Chemistry, 4, 170-176 (2008)]. This paper includes a review which covers work on a wide range of analytical applications including trace toxic metal measurement and enhancement techniques for stripping voltammetry at boron-doped diamond electrodes including the use of ultrasound energy, microwave radiation, lasers and microelectrode arrays. In the described applications a boron-doped diamond material is used for the working/sensing electrode in combination with standard counter and reference electrodes.

McGraw and Swain also describe using stripping voltammetry to analysis metal ions in solution using an electrochemical cell comprising a boron-doped diamond working electrode in combination with standard counter and reference electrodes (a carbon rod counter electrode and a silver/silver chloride reference electrode). It is concluded that boron-doped diamond is a viable alternative to Hg for the anodic stripping voltammetry determination of common metal ion contaminants [see “A comparison of boron-doped diamond thin-film and Hg-coated glassy carbon electrodes for anodic stripping voltammetric determination of heavy metal ions in aqueous media” Analytica Chimica Acta 575, 180-189 (2006)].

In addition to the stripping voltammetry techniques described above, it is also known to use spectroscopic techniques for analysing electro-deposited films. For example, Peeters et al describe the use of cyclic voltammetry to electrochemically deposit cobalt and copper species onto a gold electrode using a three electrode cell comprising a saturated calomel reference electrode, a carbon counter electrode, and a gold working electrode. The gold electrodes comprising electrochemically deposited cobalt and copper species were subsequently transferred to a synchrotron radiation X-ray fluorescence (SR-XRF) facility for SR-XRF analysis to determine the heterogeneity of the deposited layers and the concentrations of Co and Cu. A comparison of SR-XRF results with electrochemical data was used to investigate the mechanism of thin film growth of the cobalt and copper containing species [see “Quantitative synchrotron micro-XRF study of CoTSPc and CuTSPc thin-films deposited on gold by cyclic voltammetry” Journal of Analytical Atomic Spectrometry, 22, 493-501 (2007)].

Ritschel et al. describe electrodeposition of heavy metal species onto a niobium cathode. The niobium cathode comprising the electrodeposited heavy metal species is then transferred to a total reflection X-ray fluorescence (TXRF) spectrometer for TXRF analysis [see “An electrochemical enrichment procedure for the determination of heavy metals by total-reflection X-ray fluorescence spectroscopy” Spectrochimica Acta Part B, 54, 1449-1454 (1999)].

Alov et al. describe electrodeposition of heavy metal species onto a glass-ceramic carbon working electrode. A standard silver chloride reference electrode and a platinum counter electrode were used in the electrochemical cell. The glass-ceramic carbon working electrode comprising the electrodeposited heavy metal species is then transferred to a total reflection X-ray fluorescence (TXRF) spectrometer for TXRF analysis [see “Total-reflection X-ray fluorescence study of electrochemical deposition of metals on a glass-ceramic carbon electrode surface” Spectrochimica Acta Part B, 56, 2117-2126 (2001) and “Formation of binary and ternary metal deposits on glass-ceramic carbon electrode surfaces: electron-probe X-ray microanalysis, total-reflection X-ray fluorescence analysis, X-ray photoelectron spectroscopy and scanning electron microscopy study” Spectrochimica Acta Part B, 58, 735-740 (2003)].

WO 97/15820 discloses a combined surface plasmon resonance sensor and chemical electrode sensor. The electrode comprises a very thin layer of conducting or semi-conducting material which is suitable for supporting surface plasmon resonance. Materials suitable for supporting surface plasmon resonance are indicated to be reflective metals such as gold and silver although it is indicated that if these materials form a layer of 1000 angstroms or more then they will not support surface plasmon resonance. The electrode is used to electrochemical deposit species which are then stripped to generate stripping voltammetry data. The surface plasmon resonance analysis comprises reflecting a light beam off the electrode. The optical signal is used to determine an effective index of refraction and is a function of the index of refraction of materials deposited on the electrode and the thickness of the layer of material deposited on the electrode. While the surface plasmon resonance technique cannot on its own identify unknown types of chemical species it can be used in conjunction with electrochemical data to aid identification of unknown chemical species in a solution of interest. Furthermore, if the chemical species in a solution of interest are known, then the surface plasmon resonance technique can be used to determine the amount of material deposited and determine if material is left on the metallic electrode after electrochemical stripping.

The present inventors have identified a number of potential problems with the aforementioned techniques. For example, while Swain et al. and Zhang et al. have described the use of in-situ spectroscopic techniques through a transparent electrode in an electrochemical sensor to generate spectroscopic data which is complimentary to voltammetry data, the transmission IR and UV-visible spectroscopy techniques described therein are only suitable for analysis of chemical species in solution. They are not suitable for analysing species such as heavy metals electro-deposited on an electrode. Furthermore, as the species are not concentrated by electro-deposition onto an electrode surface then low concentrations of species in solution may be below the detection limit for certain spectroscopic techniques. Further still, such spectroscopic techniques only give information about chemical species in the bulk solution and do not give information about the surface of the sensor to establish, for example, when the surface of an electrode is clean or when minerals or amalgams form on an electrode surface.

In contrast, prior art stripping voltammetry techniques on diamond electrodes are advantageous for analysing species such as heavy metals which can be electro-deposited from solution as described by Jones, Compton, McGraw and Swain. However, species discrimination in multi-metal solutions can be a problem using such techniques since the peak positions can be overlapping in stripping voltammetry data. Furthermore, stripping peak positions can also depend on the type and relative concentration of metals present in the solution and the pH of the solution. For example, the presence of a plurality of metal species can affect how the metals co-deposit and strip from the electrode. Further still, the use of standard reference and counter electrodes in such arrangements means that the electrochemical sensor is not robust to harsh chemical and physical environments, even if the diamond sensing electrode is robust to such conditions.

The problem of overlapping peaks in stripping voltammetry data can potentially be solved by applying the teachings of Peeters et al, Ritschel et al., and Alov et al. These groups have suggested electro-depositing films onto gold, niobium or glass-ceramic carbon working electrodes and then extracting the electrodes from the electro-deposition apparatus and transferring the coated electrodes to a suitable device for further analysis including, for example, electron-probe X-ray microanalysis, total-reflection X-ray fluorescence analysis, X-ray photoelectron spectroscopy and scanning electron microscopy. However, this technique requires the provision of multiple devices and the extraction of coated electrode components for subsequent analysis which may not be possible for field analysis and/or in remote sensing environments, e.g. down an oil well. Furthermore, the electrodes, particularly gold, can interfere with x-ray analysis techniques such as X-ray fluorescence analysis. Furthermore, electrodes such as gold electrodes do not give particularly good electrodeposition and stripping performance. Further still, the described electro-deposition apparatus uses electrodes which are not robust to harsh chemical and physical environments.

Similar comments apply with regard to WO97/15820 which discloses that very thin metal electrodes, particularly gold, are required for supporting surface plasmon resonance in combination with stripping voltammetry. Such electrodes can interfere with spectroscopic methods suitable for identifying unknown chemical species and the described surface plasmon resonance technique is not, in itself, able to uniquely identify unknown chemical species without also combining the optical data with suitably referenced electrochemical voltammetry data. Furthermore, the thin metal electrodes required for supporting surface plasmon resonance are not robust to harsh chemical and physical environments.

It is an aim of certain embodiments of the present invention to address one or more of the aforementioned problems. In particular, certain embodiments of the present invention provide a sensor configuration for monitoring low concentrations of a plurality of chemical species in complex chemical environments. Advantageous arrangements combine this functionality in a device which is relatively compact and is suitable for use in the field and/or in remote and/or harsh sensing environments such as for oil and gas applications.

### SUMMARY OF INVENTION

The present inventors have recently proposed a combined electro-deposition and x-ray fluorescence analysis technique using electrically conductive diamond electrodes (PCT/EP2012/058761). The technique involves electro-depositing chemical species onto an electrically conductive diamond electrode and then using x-ray fluorescence spectroscopy to analyse the chemical species deposited on the electrically conductive diamond electrode. In one arrangement the electrochemical deposition step and the spectroscopic analysis step can be performed in two separate apparatus, an electrochemical deposition apparatus and a separate spectrometer. In such a two stage process, electrochemical deposition on the electrically conductive diamond electrode can be performed in the electrochemical deposition apparatus. The electrically conductive diamond electrode including the electrodeposited species can then be transferred to a spectrometer for spectroscopic analysis. After spectroscopic analysis, the first electrode including the electrodeposited species can be transferred back to the electrochemical deposition apparatus to strip the electro-deposited chemical species from the first electrode.

In the aforementioned technique, the electrically conductive diamond electrode will usually be loaded into the x-ray fluorescence spectrometer with the electro-deposited species facing the x-ray analysis beam and the detector of the emitted x-rays.

While a two stage electrochemical deposition and spectroscopic method is envisaged as a possibility in PCT/EP2012/058761, for many applications it is preferable, and in some cases essential, that the spectroscopic analysis is performed in situ within the electrochemical deposition apparatus. PCT/EP2012/058761 also envisages this possibility and suggests that an electrically conductive diamond electrode is advantageous in such an arrangement because the material is transparent to x-rays and thus the x-ray analysis can be performed through the back of the electrically conductive diamond electrode. Such a “through-electrode” configuration is considered advantageous for in-situ arrangements as otherwise the x-ray analysis must be performed through the solution being analysed which can lead to loss of sensitivity due to absorption and scattering of both the incident x-ray analysis beam and x-rays emitted from the material deposited on the electrode. Furthermore, in certain applications it is difficult to configure a system such that the x-ray analysis is performed through the solution of interest, e.g. where it is difficult to configure the system such that the solution flows between the electrode and an x-ray source and detector. As such, for these applications it is considered advantageous, or in some cases essential, for the x-ray analysis to be performed through the electrode on which the chemical species are deposited.

Certain embodiments of the present invention are concerned specifically with the aforementioned configurations in which the spectroscopic analysis is performed in situ within the electrochemical deposition apparatus and the spectroscopic analysis is performed through the electrode on which the chemical species are deposited. While PCT/EP2012/058761 envisages the use of electrically conductive diamond material in such arrangements, the present inventors have considered that such “through-electrode” arrangements could be implemented using other electrically conductive materials so long as the material and the thickness of the electrode are selected such that the electrode is substantially transparent to x-rays both in terms of an incident x-ray excitation beam and x-rays emitted by material deposited on the electrode. In addition, the present inventors have realized that one further problem with such “though-electrode” configurations is that an ohmic contact is required for the electrode in order to electrically address the electrode to perform deposition and stripping of chemical species and this is usually provided on a rear surface of the electrode. Such an ohmic contact will absorb x-rays passing through the electrode and generate background x-ray signals arising from the material used for the ohmic contact. As such, the ohmic contact will inhibit any spectroscopic analysis through the electrode. For example, titanium and gold can be used as an ohmic contact for electrically conductive diamond electrodes, but both of these materials interact with incident x-rays thus attenuating the x-rays and interfering with the spectroscopic analysis.

In light of the above, the present inventors consider that for in-situ electro-deposition and x-ray analysis using a through-electrode configuration it is important to carefully select the material and thickness of the electrode in order to provide high transmittance of exciting and emitted x-rays and in combination provide the electrode with an ohmic contact which is configured to allow transmittance of exciting and emitted x-rays through the electrode during the x-ray fluorescence spectroscopic analysis technique.

In addition to the above, the present inventors have also devised an alternative technical solution to the problem of providing in-situ electro-deposition and x-ray analysis while alleviating problems of x-ray attenuation. Rather than using a through-electrode configuration in which the electrode and ohmic contact are configured to alleviate problems of x-ray attenuation, a through-solution x-ray analysis configuration may be provided but in a configuration such that the solution being analysed does not unduly attenuate the incident exciting x-rays or the x-rays being emitted by the electro-deposited species. Such a configuration can be achieved in two different ways: (i) configuring the system such that only a very thin layer of the solution of interest is disposed over the electro-deposition electrode such that x-rays passing through the thin layer of solution are not unduly attenuated; or (ii) configuring the system such that after the electro-deposition step the solution is removed from over the electrode prior to performing the x-ray analysis technique. In either case, the x-ray analysis can be performed without the solution unduly attenuating the x-rays during the x-ray analysis technique and/or providing background signals which would otherwise reduce the sensitivity of the x-ray analysis technique.

A common feature of all the aforementioned configurations is that the sensor is configured such that it can perform both electro-deposition and in-situ x-ray fluorescence spectroscopy without unduly attenuating the x-ray excitation beam or the x-rays emitted by the electro-deposited chemical species. In practice, this is most easily tested by measuring the attenuation of the x-ray excitation beam incident on the electro-deposited chemical species.

Accordingly, one aspect of the present invention provides a sensor comprising:

a first electrode formed of an electrically conductive material and configured to be located in contact which a solution to be analysed;
a second electrode configured to be in electrical contact with the solution to be analysed;
an electrical controller configured to apply a potential difference between the first and second electrodes to electro-deposit chemical species from the solution onto the first electrode, and
an x-ray fluorescence spectrometer configured to perform an x-ray fluorescence spectroscopic analysis technique on the electro-deposited chemical species, the x-ray fluorescence spectrometer comprising an x-ray source configured to direct an x-ray excitation beam to the electro-deposited chemical species on the first electrode and an x-ray detector configured to receive x-rays emitted from the electro-deposited chemical species and generate spectroscopic data about the chemical species electro-deposited on the first electrode,
wherein the sensor is configured such that in use the x-ray excitation beam incident on the electro-deposited chemical species on the first electrode is attenuated by no more than 60%.

Preferably, the sensor is configured such that in use the x-ray excitation beam incident on the electro-deposited chemical species on the first electrode is attenuated by no more than 50%, 40%, 30%, 20%, 10%, 5%, or 1%. Furthermore, preferably the sensor is configured such that in use the x-rays emitted from the electro-deposited chemical species to the detector are attenuated by no more than 60%, 50%, 40%, 30%, 20%, 10%, 5%, or 1%. Attenuation of the x-rays emitted from the electro-deposited chemical species to the detector can be measured by electro-depositing a known amount of a known substance, taking an x-ray measurement of the species through the electrode, taking a further x-ray measurement of the species directly (i.e. not through the electrode), and subtracting the through-electrode measurement from the direct measurement to determine the degree that the x-rays emitted by the electro-deposited chemical species are attenuated on passing through the electrode.

According to certain embodiments the sensor is configured to perform the x-ray fluorescence spectroscopic analysis technique through the electro-deposition electrode. In this case, the x-ray source is configured to direct the x-ray excitation beam through the first electrode to the electro-deposited chemical species on the first electrode. Optionally, the x-ray detector is configured to receive x-rays emitted from the electro-deposited chemical species through the first electrode although it is also envisaged that the x-ray source and x-ray detector could be located on opposite sides of the electrode, i.e. with the x-ray source configured to direct the x-ray excitation beam through the electrode to the electro-deposited chemical species and the detector located to receive x-rays emitted from the electro-deposited chemical species on an opposite side of the electrode to the x-ray source. The electrically conductive material of the first electrode is selected and formed at a thickness such that the first electrode is substantially transparent to x-rays passing through the first electrode during the x-ray fluorescence spectroscopic analysis technique. Furthermore, the first electrode comprises an ohmic contact configured to allow transmittance of the x-rays through the first electrode during the x-ray fluorescence spectroscopic analysis technique. In this case, the terms “substantially transparent” and “allow transmittance” should be construed such that in use the first electrode does not attenuate the x-ray excitation beam incident on the electro-deposited chemical species by more than 60% as the x-ray excitation beam passes through the first electrode.

According to certain further embodiments the sensor is configured to perform the x-ray fluorescence spectroscopic analysis technique through the solution being analysed. In this case, the x-ray source is configured to direct the x-ray excitation beam through the solution to the electro-deposited chemical species on the first electrode. Optionally, the x-ray detector is configured to receive x-rays emitted from the electro-deposited chemical species through the solution although it is also envisaged that the x-ray source and x-ray detector could be located on opposite sides of the electrode as previously mentioned, i.e. with the x-ray source configured to direct the x-ray excitation beam through the solution to the electro-deposited chemical species and the detector located to receive x-rays emitted from the electro-deposited chemical species through the electrode. The sensor is configured such that only a thin layer of the solution is disposed over the first electrode during the x-ray fluorescence spectroscopic analysis technique such that the thin layer of solution is substantially transparent to x-rays passing through the solution. In this case, the terms “thin” and “substantially transparent” are construed such that in use the layer of solution does not attenuate the x-ray excitation beam incident on the electro-deposited chemical species by more than 60% as the x-ray excitation beam passes through the thin layer of solution.

According to certain further embodiments the sensor is configured to perform the x-ray fluorescence spectroscopic analysis technique directly on the electro-deposited chemical species and not through-solution or through-electrode. In this case, the x-ray source is configured to direct the x-ray excitation beam onto the electro-deposited chemical species on the first electrode through a solution pathway. Optionally, the x-ray detector is configured to receive x-rays emitted from the electro-deposited chemical species through the solution pathway although it is also envisaged that the x-ray source and x-ray detector could be located on opposite sides of the electrode as previously mentioned, i.e. with the x-ray source configured to direct the x-ray excitation beam through the solution pathway to the electro-deposited chemical species and the detector located to receive x-rays emitted from the electro-deposited chemical species through the electrode. The sensor is configured such that a solution of interest is disposed within the solution pathway to perform electro-deposition and then removed from the solution pathway. After removing the solution from the solution pathway the x-ray analysis technique can be performed through the solution pathway without any solution present within the pathway to unduly attenuate the x-ray excitation beam. In this case, the term “unduly attenuate” is construed such that in use the x-ray excitation beam incident on the electro-deposited chemical species is not attenuated by more than 60% as the x-ray excitation beam passes through the solution pathway.

### BRIEF DESCRIPTION OF THE DRAWINGS

For a better understanding of the present invention and to show how the same may be carried into effect, embodiments of the present invention will now be described by way of example only with reference to the accompanying drawings, in which:

FIG. 1 is a schematic diagram of a sensor according to an embodiment of the present invention;

FIGS. 2(a) and 2(b) show side cross-section and rear plan view diagrams respectively of an electro-deposition electrode configuration according to an embodiment of the invention;

FIGS. 3(a) and 3(b) show side cross-section and rear plan view diagrams respectively of an electro-deposition electrode configuration according to another embodiment of the invention;

FIG. 4 is a schematic diagram of a sensor according to another embodiment of the present invention;

FIGS. 5(a) to 5(c) illustrate the type of data generated using embodiments of the present invention;

FIGS. 6(a) and 6(b) illustrate another example of the type of data generated using embodiments of the present invention;

FIG. 7 is a schematic diagram of a sensor according to another embodiment of the present invention; and

FIGS. 8(a) and 8(b) show a schematic diagram of a sensor according to yet another embodiment of the present invention.

### DETAILED DESCRIPTION OF CERTAIN EMBODIMENTS

According to certain embodiments of the present invention the sensor structure combines electro-deposition with in-situ through-electrode x-ray fluorescence spectroscopy. The electrode material, geometry, and ohmic contact configuration are specifically adapted to achieve this combined functionality while minimizing interference from component parts and also minimizing interference from the solution being analysed. In addition, such a through-electrode geometry allows the sensor to be configured into a probe arrangement which can be inserted into a solution to be analysed with active parts performing the electro-deposition and x-ray fluorescence spectroscopy disposed behind the working electrode surface which is exposed for contacting a solution of interest, e.g. a river, a reservoir, a waste pipe, or down an oil well. The sensor configuration also allows easy integration into an industrial chemical plant flow system for in-line analysis of chemical processes. In this case, the sensor can be configured to allow solutions of interest to flow over the electro-deposition electrode with the sensor functioning to pull chemical species out of solution onto the electrode, analyse the chemical species via x-ray fluorescence spectroscopy, and then electro-chemically strip the chemical species back into solution thereby cleaning the electrode for re-use at pre-determined times allowing semi-continuous automated monitoring.

The electro-deposition electrode may be fabricated from a material at a thickness such that the electrode is substantially transparent to x-rays passing through the first electrode during the x-ray fluorescence spectroscopic analysis. Depending on the thickness of the electrode, suitable materials may include: an electrically conductive carbon material; silicon; an electrically conductive metal compound; or a metal. Examples of electrically conductive carbon material include: graphite; graphene; glassy carbon; and doped diamond material. It is considered that from a performance perspective electrically conductive diamond materials such as boron doped diamond materials are preferable. For example, in a combined electrochemical deposition and spectroscopic analysis technique it has been found that the use of a conductive diamond electrode has two main advantages over standard metal electrodes:

(i) In the electrochemical deposition step it has been found that conductive diamond material outperforms standard metal electrodes in several respects:
a. it has a broader potential window and can be driven at high voltages allowing electrochemically deposition of a wider range of chemical species at lower concentrations;
b. it is inert and can thus be used in harsh physical and chemical environments which would damage standard metal electrodes;
c. it can be more readily cleaned and re-used.

(ii) In the spectroscopic analysis step it has been found that conductive diamond material does not cause undue interference with the spectroscopic analysis of material deposited thereon. For example, in the analysis of metals it has been found that the use of a metal electrode can interfere with the spectroscopic analysis of metal species deposited thereon. Furthermore, the transparency of conductive diamond material to several spectroscopic analysis techniques, such as elemental analysis via x-ray fluorescence, allows the spectroscopic analysis to be performed through the diamond electrode allowing a sensor device to be configured with the spectrometer components behind the diamond electrode. This allows a sensor device to be configured into a probe which can be inserted into solutions to be analysed.

The use of a diamond electrode material is also advantageous as it does not form a mercury amalgam and thus enables mercury detection. A diamond electrode material is also advantageous in that a very high electrode potential can be applied to alter pH via proton or hydroxide generation. For metal ions which are complexed in solution, digests are normally performed to free them so they are available for subsequent reduction. One way to do this is to generate very strong acid (or base) conditions electrochemically. This is also useful for cleaning the electrode. While high electrode potentials can also be applied to metal electrodes to alter pH, diamond surfaces are far more stable to this process. As such, embodiments which utilize diamond electrodes have particular relevance to oil and gas operations when robust remotely operated sensors are needed, and environmental monitoring where mercury sensitivity, long term stability, and autonomous calibration is highly advantageous.

In light of the above, it is clear that diamond material has advantages over metal electrodes which are particular to the combined electrochemical deposition and spectroscopic analysis technique as described herein and are distinct from those which are applicable to electrochemical sensing such as by stripping voltammetry. That said, other x-ray transparent electrodes could be used for certain applications, e.g thin film carbon or graphene on glass, thin film silicon, ITO, or thin film metals (trading x-ray transparency against conductivity). Thin metal films comprising iridium or beryllium may also be useful as they have a relatively wide cathodic solvent window. Such materials may be utilized to reduce cost in applications where the extreme properties of diamond material are not essential.

The material and thickness of the electro-deposition electrode should be selected in order to ensure that the electrode is substantially transparent to x-rays used in the spectroscopic analysis technique. The thickness of electrode material which can be utilized will be dependent on the intrinsic transparency of the electrode to x-rays at a given energy. However, it is considered that the thickness of the electrode through which the x-rays pass during the x-ray fluorescence spectroscopic analysis technique is advantageously no more than 100 μm, 75 μm, 50 μm, 40 μm, 30 μm, 20 μm, 10 μm, 5 μm, or 2 μm, at least across a volume of the electrode through which the x-rays pass during the x-ray fluorescence spectroscopic analysis technique. In this regard, it has been found that even relatively x-ray transparent materials such as diamond materials significantly attenuate the x-ray beam used in x-ray spectroscopic techniques when provided at significant thicknesses. As such, the electrode material should be made relatively thin.

In addition, variations in thickness of the electro-deposition electrode material can lead to variations in x-ray attenuation across the electrode and this can result in non-uniform sensitivity. Accordingly, it is desirable to process the electrode to have a highly uniform thickness. For example, the electro-deposition electrode may be processed to have a thickness variation of no more than 50 μm, 40 μm, 30 μm, 20 μm, 10 μm, 5 μm, 1 μm, 500 nm, or 100 nm, at least across a volume of the electro-deposition electrode through which the x-rays pass during the x-ray fluorescence spectroscopic analysis technique.

The electro-deposition electrode should comprise an ohmic contact configured to allow transmittance of the x-rays through the electrode during the x-ray fluorescence spectroscopic analysis technique. One way to achieve this is to pattern the ohmic contact to provide a window through which the x-rays pass during the x-ray fluorescence spectroscopic analysis technique. An alternative option is to provide an ohmic contact which is configured such that the x-rays pass through at least a portion of the ohmic contact during the x-ray fluorescence spectroscopic analysis technique. In this case, the ohmic contact should be formed of a material at a thickness such that the ohmic contact is substantially transparent to x-rays passing through the ohmic contact during the x-ray fluorescence spectroscopic analysis technique. For example, the ohmic contact may comprise a thin layer of graphite which is substantially transparent to x-rays.

Using the aforementioned structural features, it is possible to configure an electrode such that the x-ray excitation beam incident is attenuated by no more than 60%, 50%, 40%, 30%, 20%, 10%, 5%, or 1% on passing through the electrode. Furthermore, it is possible to configure an electrode such that x-rays emitted from the electro-deposited chemical species are attenuated by no more than 60%, 50%, 40%, 30%, 20%, 10%, 5%, or 1% on passing through the electrode.

After electro-deposition and spectroscopic analysis the electrode may be cleaned for re-use. This may be achieved by removal and acid cleaning of the electrode. Alternatively, the electrode may be cleaned in situ. In this case, the apparatus is provided with an electrical controller which is configured to change the applied potential to strip the electro-deposited chemical species from the electrode.

In certain arrangements the x-ray fluorescence spectroscopic data alone is used to measure the type and, optionally, quantity of chemical species. In such arrangements, improved spectroscopic sensitivity is achieved in situ by using electrochemical deposition combined with a configuration which provides minimal spectroscopic interference. Alternatively, electric current can be measured during stripping of the electro-deposited chemical species thereby generating voltammetry data for the electro-deposited chemical species. In such arrangements, the electro-deposition electrode is functioning as an electrochemical sensing electrode and a second electrode functions as a reference electrode in an electrochemical sensor configuration. A processor may be configured to use the spectroscopic data and the voltammetry data to determine the type and quantity of chemical species in the solution. For example, the spectroscopic data may be used to determine the type of chemical species deposited on the sensing electrode and the voltammetry data can be used to determine the quantity of chemical species deposited on the sensing electrode. In such arrangements, the x-ray fluorescence spectroscopic data can be used to improve in-situ discrimination between electrochemical species and aid in resolving and assigning peaks in the voltammetry data. Alternatively, controlled electrochemical deposition can be utilized to selectively deposit chemical species and thus separate x-ray peaks which would otherwise overlap. Accordingly, a sensor can be provided which is suitable for monitoring low concentrations of a plurality of chemical species in complex chemical environments, which is relatively compact, and is suitable for use in the field and/or in remote sensing environments without requiring extraction and further analysis.

In addition to improving sensitivity and species discrimination, the spectroscopic data can also be used to assign peaks in the voltammetry data without requiring a standard reference electrode which maintains a fixed constant potential with respect to the sensing (i.e. working) electrode irrespective of the solution conditions. This enables the use of a more robust reference electrode which may also be made of an electrically conductive diamond material.

Embodiments of the present invention may have several advantageous features including one or more of the following:
(1) Improved in-situ spectroscopic sensitivity by concentrating species using electro-deposition;
(2) Improved in-situ species discrimination in a multi-species solution by making comparative spectroscopic and electrochemical measurements;
(3) Internal calibration allowing the use of a more robust reference electrode; and
(4) Reduced spectroscopic interference from solution and device components.

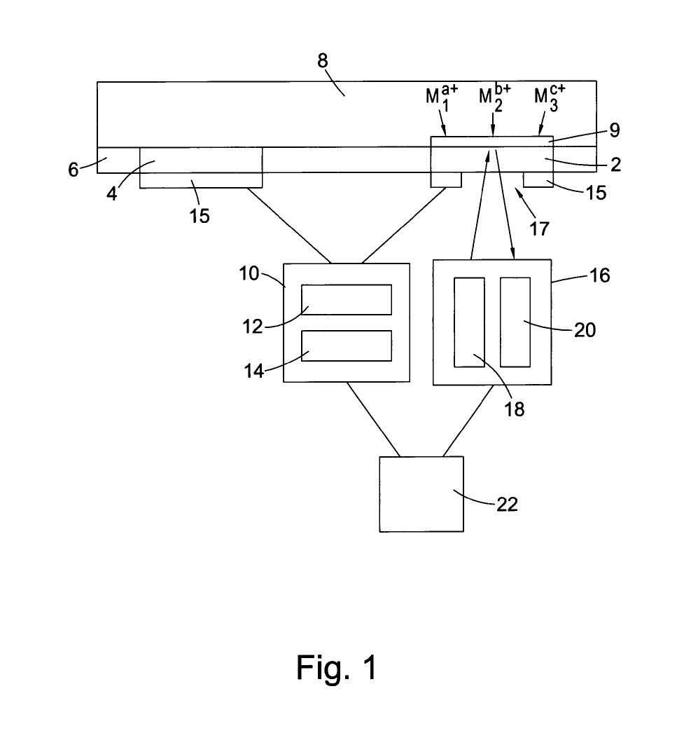

FIG. 1 shows a sensor which combines electro-deposition and x-ray spectroscopic analysis techniques. The sensor comprises two electrodes 2, 4 mounted in a support substrate 6. The electrodes 2, 4 are configured to be located in contact with a solution 8 in use. While the illustrated arrangement comprises two electrodes including an electro-deposition electrode 2 and a reference electrode 4, it is to be noted that the supporting substrate may only comprise an electro-deposition electrode 2 with a separate electrode being inserted into the solution to function as a reference electrode 4. In operation, chemical species M₁^{a+}, M₂^{b+}, and M₃^{c+} can be electro-deposited onto the electrode 2 forming a solid layer 9 comprising species M₁, M₂, and M₃ and subsequently electro-stripped from the electrode back into solution.

The two electrodes 2, 4 are electrically coupled to an electrical controller 10 which comprises a voltage control unit 12 and a current or charge measurement unit 14. The voltage control unit 12 is configured to apply a potential difference between the two electrodes 2, 4. A counter electrode (not shown) may also be provided if required.

The electrodes 2, 4 are provided with ohmic contacts 15 on a rear surface thereof. The ohmic contact 15 on the rear surface of the electro-deposition electrode 2 is patterned to provide a window 17 through which x-rays can pass to and from the solid layer 9 deposited on a front surface of the electrode 2 in order to perform x-ray spectrometry on the solid layer 9.

The sensor further comprises an x-ray spectrometer 16 configured to perform elemental analysis of solid species 9 which have been electro-deposited onto the sensing electrode 2. The spectrometer comprises an x-ray emitter 18 and a detector 20. In the illustrated arrangement, the x-ray spectrometer is configured to perform a spectroscopic analysis of the solid species 9 through the sensing electrode 2 via a window in the ohmic contact 15. As such, the electrode 2 should be made of a material at a thickness which is substantially transparent to the x-rays used in the spectroscopic analysis as previously described.

The electrochemical sensor further comprises a data processor 22 which is configured to receive data from both the electrical controller 10 and the spectrometer 16. This data will be in the form of (optional) stripping voltammetry data or associated electrochemical data from the electrical controller 10 and spectroscopic data from the spectrometer 16. Both types of data are capable of given information about the type and quantity of metal species electro-deposited onto the electrode 2.

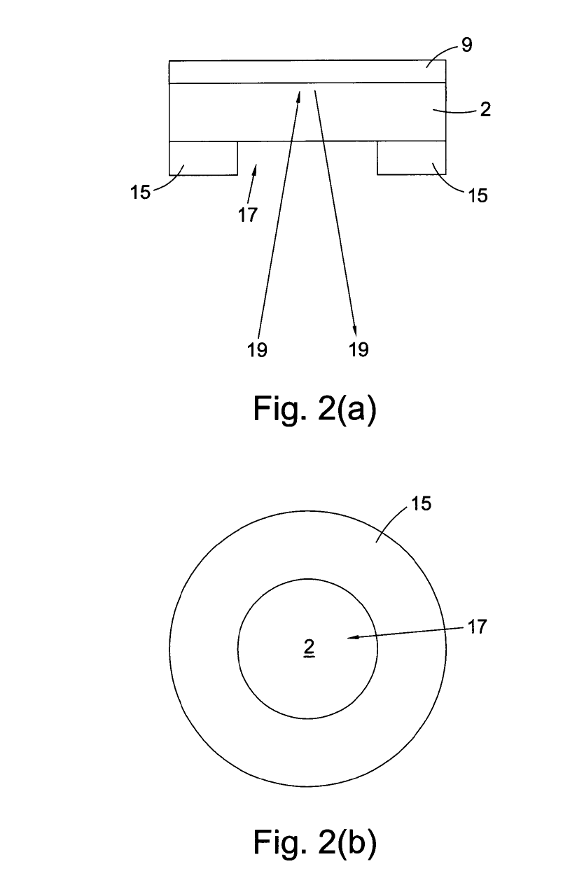

FIGS. 2(a) and 2(b) show cross sectional and rear plan views respectively of the electro-deposition electrode 2 comprising a patterned ohmic contact 15. A window 17 is provided in the ohmic contact through which x-rays 19 can pass to and from a solid layer 9 deposited on a front surface of the electrode 2 in order to perform x-ray spectrometry on the solid layer 9.

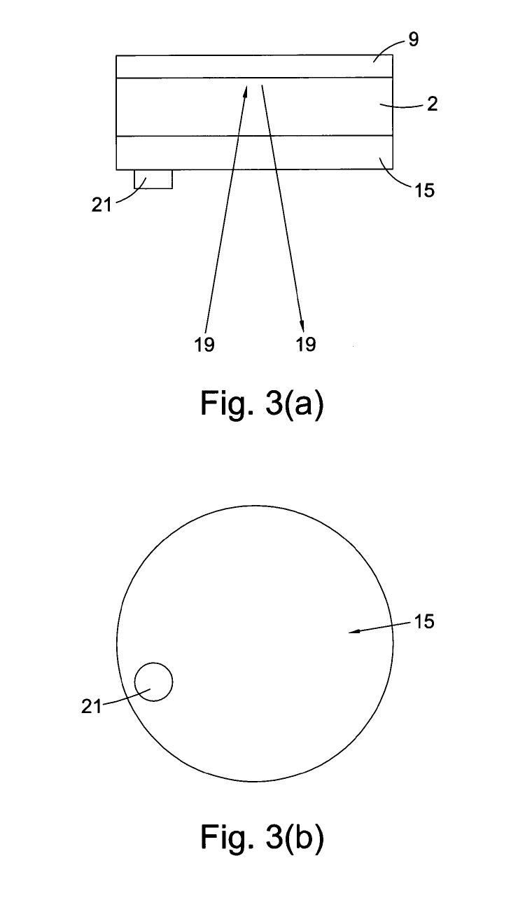

FIGS. 3(a) and 3(b) show cross sectional and rear plan views respectively of an alternative arrangement for the electrode 2 comprising an ohmic contact 15. In this case, no window is provided in the ohmic contact but rather the ohmic contact is formed of a material at a thickness such that the ohmic contact is substantially transparent to x-ray which can thus pass to and from a solid layer 9 deposited on a front surface of the electrode 2 in order to perform x-ray spectrometry on the solid layer 9. For example, if the electrode 2 is a diamond electrode then the rear surface may be grapitized to provide a thin graphitic ohmic contact across the rear surface of the electrode. Metallization 21 to the thin graphitized surface will still be required to provide an electric contact and this should be located away from the area through which x-rays pass in use.

In FIGS. 1 to 3 the electro-deposition electrode is illustrated as having a constant thickness. However, as it is desirable to provide a thin electrode structure across the region through which x-rays pass to reduce x-ray attenuation, it may be desirable to provide a relatively thick electrode for mechanical robustness and thin the electrode only at the region through which the x-rays pass. This may be achieved by processing the rear surface of the electrode with, for example, a laser to provide a thin x-ray window in the electro-deposition electrode structure. Thinning the electrode will tend to reduce its mechanical strength. As such, it may be desirable to only thin a small area of the electrode to alleviate problems of mechanical failure of a large thin region. One configuration may utilize a plurality of thinned regions with thicker regions of electrode material disposed therebetween to provide mechanical support. In this case, the x-rays may pass through a plurality of thinned electrode regions which are separated by thicker supporting ribs of material which are substantially opaque to the x-rays.

In use, it is important that the electro-deposition electrode is precisely and reproducibly positioned relative to the x-ray spectrometer. For example, if the electro-deposition electrode is accidentally mounted at a slight angle then the path length of x-rays passing through the electro-deposition electrode will be changed thus changing attenuation of the x-ray beam. In addition, the angle of the electro-deposited metal layer will be displaced from the optimum orientation required for maximizing detection of the x-rays emitted from the electro-deposited layer at the detector. This can reduce the sensitivity of the sensor and introduce errors into the spectroscopic measurement. Accordingly, it is advantageous to provide a mounting arrangement which allows precise alignment of the electro-deposition electrode with the electro-deposition electrode having a precisely defined geometry. An alternative, or in addition, it can be useful to provide an adjustable mounting stage such that the electro-deposition electrode can be angularly adjusted to an optimum orientation. This may be achieved by measuring the intensity of detected x-rays and adjusting the orientation of the electro-deposition electrode to maximize detection intensity.

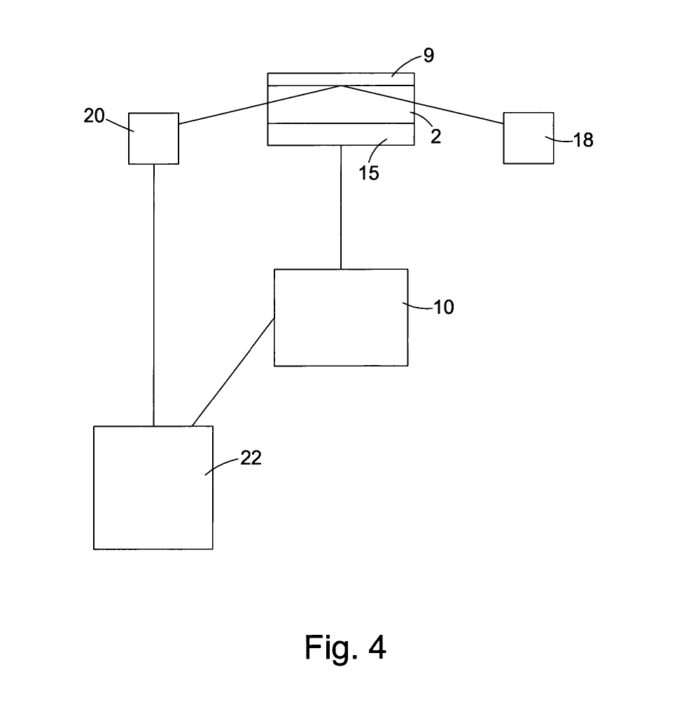

In FIGS. 1 to 3 the x-rays are illustrated as passing through a rear surface of the electro-deposition electrode at a relatively steep angle. However, shallow angle “total reflection” x-ray spectrometer configurations are known in the art and such configurations may be utilized with the present invention. In this case, the x-ray source and detection may be configured more laterally relative to the electro-deposition electrode and x-rays may pass through side faces of the electro-deposition electrode as illustrated in FIG. 4. The sensor illustrated in FIG. 4 comprises similar components to that illustrated in FIG. 1 including an electro-deposition electrode 2 on which a layer of species 9 can be electro-deposited. An electrical controller 10 is coupled to the electro-deposition electrode via an ohmic contact 15. The x-ray spectrometer comprises an x-ray source 18 and a detector 20. The x-ray spectrometer and the electrical controller are coupled to a processor 22 which is configured to receive and process data from both the electrical controller and the spectrometer.

The main difference with the sensor configuration illustrated in FIG. 4 compared to that illustrated in FIG. 1 is the shallow angle x-ray configuration. X-rays in this configuration pass through side faces of the electro-deposition electrode. This can increase the path length of the x-rays through the electrode which is not desirable as it can lead to increased x-ray beam attenuation. However, the arrangement is advantageous in that no patterning of a rear ohmic contact 15 is required. That is, by re-configuring the x-ray source and detector such that x-rays pass through the electrode via side faces, the ohmic contact is configured relative to the x-ray beam path to naturally allow transmittance of the x-rays through the electro-deposition electrode.

One further problem with the shallow angle configuration illustrated in FIG. 4 is that the shallow-angle configuration is more sensitive to angular variations of the electro-deposition electrode. As such, it is even more important that the electro-deposition electrode is fabricated with a very high degree of surface flatness and that the electrode is very precisely mounted and oriented in use as previously described. For example, the working surface of the electrode may be fabricated to have a flatness variation of no more than 5 μm, 1 μm, 500 nm, 300 nm, 100 nm, 50 nm, or 20 nm, at least across an area where the x-ray analysis is performed.

Optionally a polarizer is provided to polarize the incident x-ray beam prior to passing the beam through the electro-deposition electrode. This can further increase sensitivity by reducing the intensity of unwanted scattered x-rays incident on the detector.

A variety of electrode structures are envisaged for use with embodiments of the present invention. For example, the electrodes may be formed as one or more macroelectrodes or in the form a microelectrode array. Microelectrode arrays can be advantageous in achieving a more efficient electro-deposition. Furthermore, a plurality of electrodes can be utilized to optimize deposition and stripping conditions, e.g. by electrochemically optimizing pH conditions for deposition and stripping of species of interest. For example, the sensor may include an electro-deposition electrode and a further electrode configured adjacent to the electro-deposition electrode (e.g. in a ring around the electro-deposition electrode) to manipulate solution conditions by, for example, electrochemically varying the pH of the solution in the immediate vicinity of the electro-deposition electrode thereby enhancing electro-deposition of certain species of interest. Electrochemically controlling pH during deposition can result in some species being preferentially deposited compared to others.

The sensor may further comprise a flow cell such that the solution of interest is circulated past the electrode 2 during electro-deposition. The solution may be re-circulated past the electrode 2 multiple times during the electro-deposition cycle in order to increase the quantity of species electro-deposited onto the electrode and thus increase sensitivity at low concentrations.

In order to determine the concentration of a species of interest in a solution a known volume of solution can be completely depleted of the species of interest during the electro-deposition process. Using a flow cell as previously described can be useful for depleting a larger volume of solution and thus increasing sensitivity at very low concentrations. Alternatively, or additionally, electric current measurements can be used in combination with solution volume measurements and known mass transport equations in order to calibrate the device such that x-ray spectroscopic data from deposited species can be converted into concentrations of species in the solution of interest.

The sensor shown in FIG. 1 can be used in a method of measuring target species as follows:
locate the electrodes 2, 4 in contact with a solution to be analysed;
apply a potential difference between the electrodes 2, 4 to electro-deposit chemical species from the solution onto the electrode 2;
apply an x-ray spectroscopic analysis technique through the electrode 2 to generate spectroscopic data about the chemical species electro-deposited onto the electrode 2; and
process the spectroscopic data to determine the type and/or quantity of chemical species in the solution.

Optionally, the method further comprises changing the voltage applied to the electrode 2 to strip the electro-deposited chemical species from the sensing electrode. This may be via electrochemical stripping and/or by electrochemically changing the pH of the solution. The method may also further comprise measuring an electric current or charge during the electro-stripping thereby generating stripping voltammetry data or associated electrochemical data.

The above procedure can be repeated, and data from one cycle can be combined with data from another cycle if required. For example, spectroscopic and voltammetric data may be acquired on separate cycles. Alternatively, repeat cycles may use different voltage/current/dwell parameters, for example to assist in peak separation.

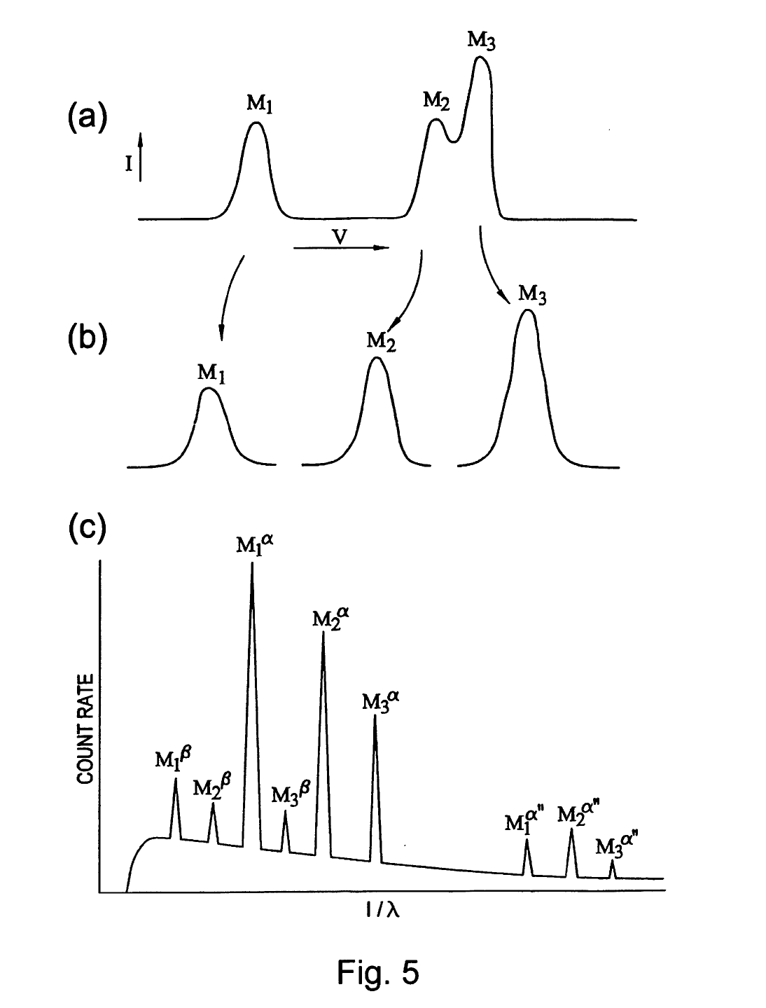

FIGS. 5(a) to 5(c) illustrate an example of data generated using the aforementioned method. FIG. 5(a) shows a stripping voltammogram generated by the electrical controller. The stripping voltammogram comprises oxidation peaks for three species M₁, M₂, and M₃. Although there is some overlap between the peaks, they are sufficiently separated that the stripping voltammogram can be deconvoluted into three separate voltammograms, one for each species as illustrated in FIG. 5(b). These voltammograms can be used to identify the type and quantity of each species by peak location and area measurements. In practice, this can be done numerically or by generating pictorial representations of the voltammetry data. For example, the composite voltammogram can be deconvoluted using Fourier analysis techniques. Peak locations can be compared to a reference potential to identify different target species of interest. The peaks can be numerically integrated in order to determine quantitative information about the individual species. These techniques are known to those skilled in the art.

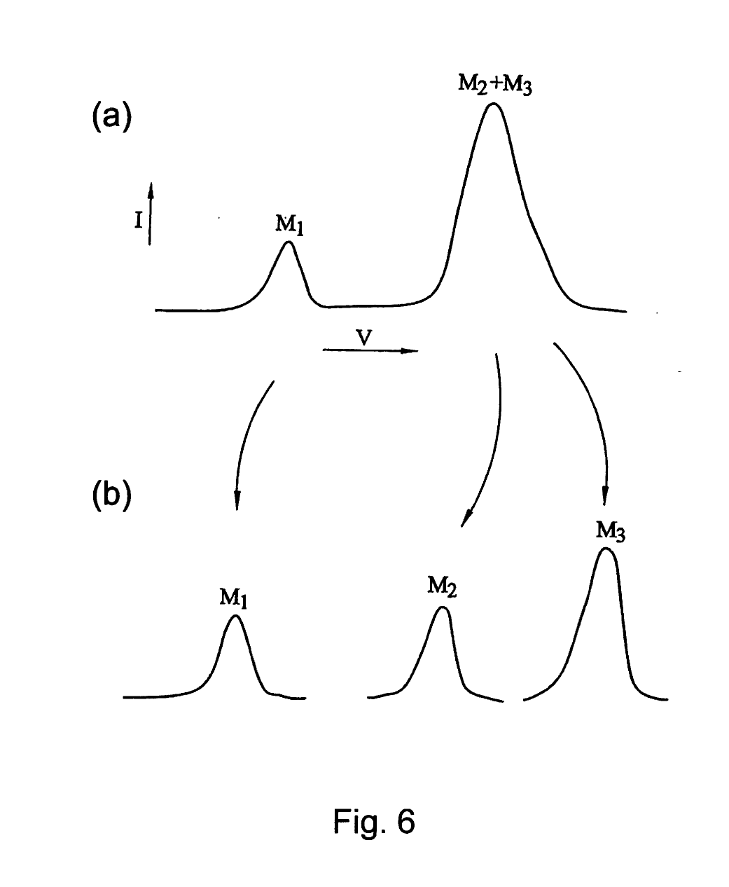

In addition to the voltammetry data discussed above, FIG. 5(c) illustrates an XRF spectrum obtained by the spectrometer 16. The spectrum K_{α}, K_{β}, and second order K_{α}″ lines for the three metal species previously discussed. This spectroscopic information can also be used to determine the type and quantity of species electro-deposited on the sensing electrode 2. In the event that the target species are individually identifiable and quantifiable in the stripping voltammetry data, the spectroscopic data may merely serve to confirm results obtain via stripping voltammetry or be used as a reference for assigning peaks in the voltammetry data. In the case that one or more of the target species have overlapping peak in the stripping voltammetry data such that the data cannot be readily be deconvoluted, the spectroscopic data can either be used as a means to deconvolute the voltammetry data or otherwise used instead of the voltammetry data to identify and quantify individual target species. For example, FIG. 6(a) shows a stripping voltammogram for three target species M₁, M₂, and M₃ where the peaks for species M₂ and M₃ completely overlap. Decovolution of this voltamogram without any other information may result in the erroneous identification of only two species, e.g. M₁ and M₂ only or M₁ and M₃ only, or otherwise give an ambiguous result indicating that M₂ and/or M₃ may be present. In this case, spectroscopic data as indicated in FIG. 5(c) can be used to correctly deconvolute the composite voltammogram illustrated in FIG. 6(a) into its three constituent parts as shown in FIG. 6(b). Alternatively, the spectroscopic data could be used on its own, the electrical controller merely being utilized as a means of depositing species for spectroscopic analysis. However, in practice the voltammetry data and the spectroscopic data can provide complimentary information. For example, the spectroscopic data can give elemental information which may not be resolved in the voltammetry data whereas the voltammetry data may give information relating to the oxidative state of species within the solution which cannot be identified from the spectroscopic data. The voltammetry data will also be more sensitive to species present at low concentration.

Alternatively, or in addition to, the above, a non-fixed reference electrode may be utilized, such as a doped diamond reference electrode, and the spectroscopic data may be used to assign peaks in the stripping voltammogram when no fixed reference potential is present. In this case, although the potential at which individual peaks will vary, the sequence of species observed in the stripping voltammogram will be fixed. As such, by identifying the species present in the solution using spectroscopy, the identified species can be assigned to the stripping voltammetry peaks given the known sequence.

As previously discussed, the use of a diamond electrode material in combination with an x-ray spectroscopic analysis technique is considered to be particularly preferable for implementing the present invention. Compact x-ray sources are commercially available. Alternatively, the diamond material may be used as an in-situ x-ray source, e.g. by coating a boron doped diamond material with a metal such as copper to form an x-ray source.

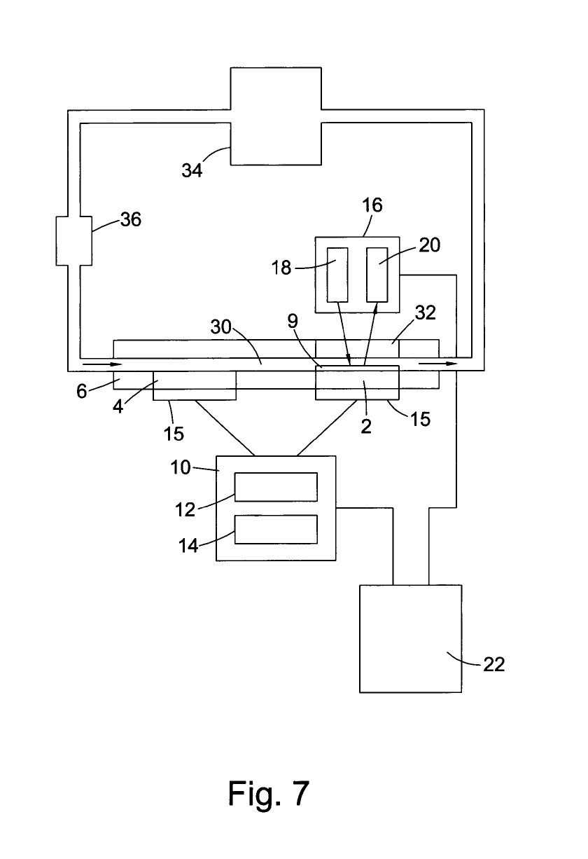

The sensor structures illustrated in FIGS. 1 to 4 are configured to perform electro-deposition and in-situ x-ray fluorescence spectroscopy through the working electrode. However, according to certain further embodiments the sensor may be configured to perform the x-ray fluorescence spectroscopic analysis technique through the solution being analysed. Such a sensor configuration is illustrated in FIG. 7. As the sensor shares many common components with the sensor structures illustrated in FIGS. 1 to 4 like reference numerals have been used for like parts. The sensor comprises two electrodes 2, 4 mounted in a support substrate 6. The electrodes 2, 4 are configured to be located in contact with a solution in use. In operation, species from solution can be electro-deposited onto the electrode 2 forming a solid layer 9 subsequently electro-stripped from the electrode back into solution. The two electrodes 2, 4 are electrically coupled to an electrical controller 10 which comprises a voltage control unit 12 and a current measurement unit 14. The voltage control unit 12 is configured to apply a potential difference between the two electrodes 2, 4. The electrodes 2, 4 are provided with ohmic contacts 15 on a rear surface thereof. The ohmic contact 15 on the rear surface of the electro-deposition electrode 2. The sensor further comprises an x-ray spectrometer 16 configured to perform elemental analysis of solid species 9 which have been electro-deposited onto the electrode 2. The spectrometer comprises an x-ray emitter 18 and a detector 20. The sensor further comprises a data processor 22 which is configured to receive data from both the electrical controller 10 and the spectrometer 16.

In the aforementioned respects the sensor of FIG. 7 is the same as that illustrated in FIGS. 1 to 4. The sensor of FIG. 7 differs in that the x-ray spectrometer 16 is configured to perform the spectroscopic analysis of the solid species 9 through the solution path 30 rather than through the electrode 2. The sensor is configured such that only a thin layer of the solution is disposed over the first electrode during the x-ray fluorescence spectroscopic analysis technique such that the thin layer of solution is substantially transparent to x-rays passing through the solution. For example, the thin layer of solution may have a thickness of no more than 300 μm, 200 μm, 100 μm, 75 μm, 50 μm, 40μm, 30 μm, or 20 μm, at least across a volume of the solution through which the x-rays pass during the x-ray fluorescence spectroscopic analysis technique. One way to achieve such a thin layer of solution is to provide a very thin solution channel 30 over the electro-deposition electrode, the channel 30 having a thickness of no more than 300 μm, 200 μm, 100 μm, 75 μm, 50 μm, 40 μm, 30 μm, or 20 μm. In the illustrated arrangement such a channel 30 is provided and solution is pumped through the microfluidic channel from a reservoir 34 by a pump 36. The solution channel 30 comprises an x-ray window 32 opposite the electrode 2 for transmitting x-rays through the solution channel 30 to chemical species 9 electro-deposited on the electrode 2. The x-ray window 32 may also be formed of a diamond material. In one arrangement the channel 30 may be formed by fabricating a hole through a diamond material in which electrode structures have been formed. Alternatively, it is possible to provide a thin layer of solution without the provision of a thin solution channel. That is, the sensor may be configured to flow a thin layer of solution over the electro-deposition electrode with a gas or vacuum located over the thin layer of solution. In this case, the electro-deposition electrode could be angled such that a thin layer of solution flows across its surface under the action of gravity. While such a configuration may have some draw backs in terms of its ability to pump relatively large volumes across the surface of the electro-deposition electrode in a relatively small time scale, the configuration does have the additional advantage that an x-ray window opposite the electrode is not required and thus any additional x-ray beam attenuation attributable to such an x-ray window may be avoided.

In other respects the configuration of FIG. 7 functions in a similar manner to the sensor configurations of FIGS. 1 to 4 and the same comments apply.

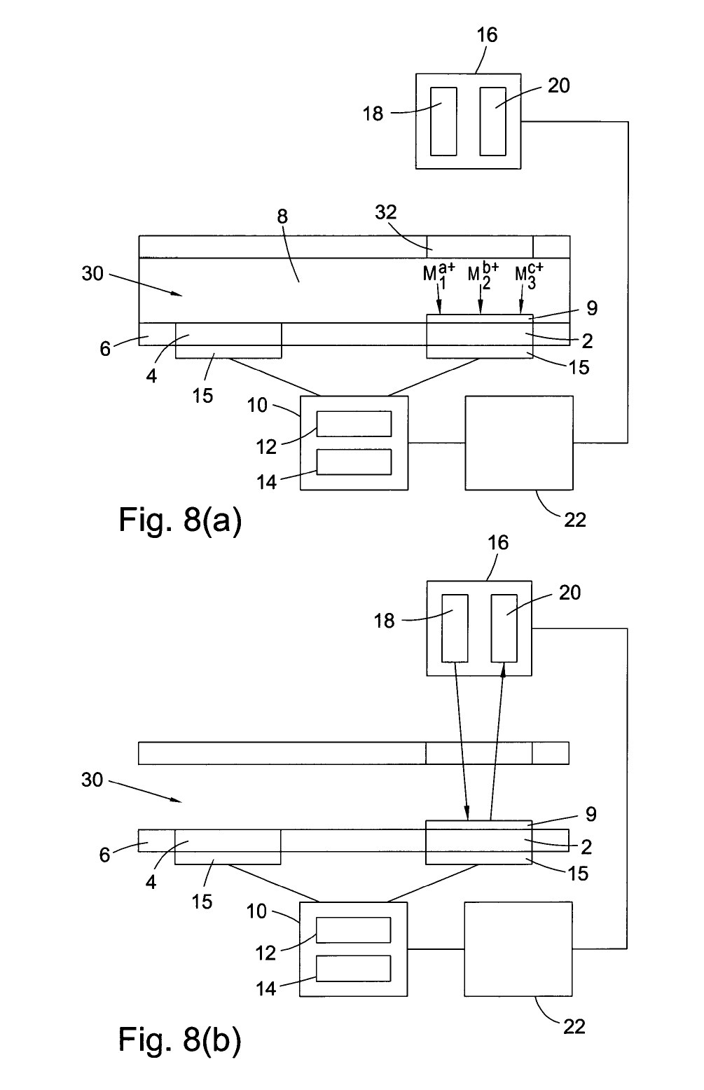

FIGS. 8(a) and 8(b) illustrate yet another sensor configuration. Again, the sensor shares many common components with the sensor structures illustrated in FIGS. 1 to 4 and 7 and thus like reference numerals have been used for like parts. The sensor comprises two electrodes 2, 4 mounted in a support substrate 6. The electrodes 2, 4 are configured to be located in contact with a solution 8 in use. In operation, species from solution can be electro-deposited onto the electrode 2 forming a solid layer 9 subsequently electro-stripped from the electrode back into solution. The two electrodes 2, 4 are electrically coupled to an electrical controller 10 which comprises a voltage control unit 12 and a current measurement unit 14. The voltage control unit 12 is configured to apply a potential difference between the two electrodes 2, 4. The electrodes 2, 4 are provided with ohmic contacts 15 on a rear surface thereof The ohmic contact 15 on the rear surface of the electro-deposition electrode 2. The sensor further comprises an x-ray spectrometer 16 configured to perform elemental analysis of solid species 9 which have been electro-deposited onto the electrode 2. The spectrometer comprises an x-ray emitter 18 and a detector 20. The sensor further comprises a data processor 22 which is configured to receive data from both the electrical controller 10 and the spectrometer 16.

In the aforementioned respects the sensor of FIG. 8 is the same as that illustrated in FIGS. 1 to 4 and 7. Furthermore, as in the arrangement of FIG. 7, the x-ray spectrometer 16 is configured to perform the spectroscopic analysis of the solid species 9 through the solution path 30 rather than through the electrode 2 as in the arrangement of FIGS. 1 to 4. Unlike the arrangement of FIG. 7, a thin microfluidic channel is not required. Rather, the sensor of FIG. 8 is configured such that a solution of interest 8 is disposed within the solution pathway to perform electro-deposition as shown in FIG. 8(a) and then removed from the solution pathway to perform the x-ray fluorescence spectroscopic analysis technique as shown in FIG. 8(b). As the solution is removed from the solution pathway prior to performing the x-ray analysis technique then the x-rays are not unduly attenuated by the solution.

A number of different configurations can be provided to inject a solution of interest into the solution pathway for electro-deposition and subsequently remove the solution from the solution pathway to perform the x-ray analysis. For example, a pump may be provided to perform such a function. Alternatively, or additionally, one or more valves may be provided to open and close the solution pathway to allow introduction and removal of solution from the solution pathway.

In other respects the configuration of FIG. 8 functions in a similar manner to the sensor configurations of FIGS. 1 to 4 and the same comments apply.

It should be noted that it is also possible to locate the x-ray source and x-ray detector on opposite sides of the electro-deposition electrode to operate in a transmission XRF mode. For example, the configuration illustrated in FIG. 1 could be modified such that the x-ray detector is located above the electro-deposition electrode such that the x-ray excitation beam passes through the electro-deposition electrode but x-rays emitted from the sample are detected from a top-side of the electro-deposited layer. Similarly, the configuration illustrated in FIG. 7 could be modified such that the x-ray excitation beam passes through the solution but the x-ray detector is located below the electro-deposition electrode such that x-rays emitted from the sample are detected from a bottom-side of the electro-deposited layer. Similarly, the configuration illustrated in FIG. 8 could be modified such that the x-ray excitation beam passes through the solution pathway but the x-ray detector is located below the electro-deposition electrode such that x-rays emitted from the sample are detected from a bottom-side of the electro-deposited layer. In this regard it will be noted that x-rays emitted by the sample will be emitted in all directions and thus could be detected from either side of the electro-deposition electrode although the problems of x-ray attenuation will need to be taken into account as described herein.

Furthermore, in addition to the previously described arrangements for reducing x-ray attenuation it is also possible to increase the energy of the x-ray source to further reduce attenuation of the x-ray excitation beam. In generally, a higher energy x-ray excitation beam will be attenuated less by the electrode material or solution.

The integration of a spectrometer into an electrochemical sensor in the manner described herein will increase functionality and performance in terms of resolution and sensitivity for analysing solutions which contain a plurality of different target species of interest. Previously, for solutions which comprise a number of different species having overlapping voltammetry peaks, for example a number of heavy metal species having similar electrochemical potentials, it may only have been possible to determine the total species content, e.g. the total heavy metal content. In contrast, embodiments of the present invention allow identification and quantification of a large range of different species in a single solution even when voltammetry peaks overlap.

Various different electrode structures may be utilized with the combined electrochemical/spectroscopic techniques described herein. Some examples of prior art diamond electrode arrangements are discussed in the background section. In addition to the provision of a diamond sensing electrode, as previously described it is also advantageous to provide a diamond reference electrode. If the reference electrode is made of, for example, Ag/AgCl or Hg/Hg₂Cl₂ (common reference electrodes) then the reference electrode may be contaminated or attacked in aggressive environments. Using a diamond reference is preferable as it will not be etched and has a high dimensional stability in aggressive chemical/physical environments. Providing an integrated spectrometer to aid in assigning voltammetry allows such a non-fixed potential reference electrode to be utilized.

Other useful techniques may be combined with the electrochemical/spectroscopic techniques described herein. For example, differential potential pulse programmes can be used to increase sensitivity. Furthermore, the temperature of the sensing electrode can be changed to alter mass transport, reaction kinetics, and alloy formation. For example, heating during stripping voltammetry can aid in increasing peak signals. Heating during deposition can aid formation of better alloys and can also increase mass transport, shortening deposition times and/or increasing deposition to within the detection sensitivity of spectroscopic techniques such as XRF. Accordingly, in certain arrangements configured to detect very low concentrations of chemical species in solution a heater may be provided within the electrochemical sensor for heating the sensing electrode to increase deposition to within the limits of the spectroscopic analysis technique. The use of diamond material for the sensing electrode is also useful in this regard as diamond material can be heated and cooled very quickly. The high electrode potential of diamond material and the stability of diamond material when applying high potentials can also be utilized to alter pH via electrochemical generation. For metal ions which are complexed in solution, digests are normally performed to free them so they are available for subsequent reduction. One way to do this is to generate very strong acid (or base) conditions electrochemically. Furthermore, certain chemical species can be electro-deposited and/or stripped in a more well defined manner under certain pH conditions.

Generating very strong acid (or base) conditions electrochemically, or other species such as ozone or hydrogen peroxide, is also useful for cleaning the electrode. Other cleaning techniques may involve abrasive cleaning and/or heating. Again, use of a diamond material is advantageous in this regard as the diamond material is robust to abrasive, chemical, and/or heat treatments for cleaning and thus a good sensing surface can be re-generated between analysis cycles. In order to ensure that the sensing electrode is clean after a sensing cycle and prior to initiation of a further cycle an additional spectroscopic analysis and/or an electro-stripping cycle may be applied to determine if the sensing electrode is clean. For example, residual chemical species adhered to the electrode may be evident in voltammetry and/or spectroscopic data generated during such a cleanliness checking step. If so, a cleaning cycle can be performed. A further spectroscopic analysis and/or an electro-stripping cycle may than be applied to confirm that the sensing electrode is sufficiently clean for further use. As such, cleaning and checking of electrode surfaces can be performed in-situ.

Embodiments of the present invention thus provide a number of advantageous features including one or more of the following:

1. Species discrimination in multi-species solutions, even where peak positions are overlapping in anodic stripping voltammetry.

2. In-situ calibration of species even when there is an inter-dependency of peak area in voltammetry data due to inter-metallic formations or amalgams which may otherwise make specific species discrimination difficult.

3. Creating a reference for assigning peaks in voltammetric data even when a standard reference electrode is not use, thus allowing a more robust reference electrode to be utilized such as one made of a diamond material. Certain embodiments can provide an autonomous quantification/calibration of the sensor device in-situ.

4. Detecting mercury in an environmentally friendly manner, since existing electrodes typically use gold mercury amalgams or mercury itself which is considered to be environmentally unsound.

5. In-situ cleaning of the surface of electrodes, prior to use and after a metal deposition/stripping cycle has been completed thus avoiding the requirement to prepare the electrode surfaces ex-situ prior to each measurement, which may be a requirement of current commercial sensors based on gold mercury amalgams.

6. The ability to detect and quantify a large range of chemical species in complex solution environments including, for example, calcium (“scaling capacity”), copper, zinc, cadmium, mercury, lead, arsenic, aluminum, antinomy, iodine, sulphur, selenium, tellurium, and uranium, etc.

While this invention has been particularly shown and described with reference to preferred embodiments, it will be understood to those skilled in the art that various changes in form and detail may be made without departing from the scope of the invention as defined by the appendant claims.

1. A sensor comprising:
a first electrode formed of an electrically conductive material and configured to be located in contact with a solution to be analysed;
a second electrode configured to be in electrical contact with the solution to be analysed;
an electrical controller configured to apply a potential difference between the first and second electrodes to electro-deposit chemical species from the solution onto the first electrode, and
an x-ray fluorescence spectrometer configured to perform an x-ray fluorescence spectroscopic analysis technique on the electro-deposited chemical species, the x-ray fluorescence spectrometer comprising an x-ray source configured to direct an x-ray excitation beam to the electro-deposited chemical species on the first electrode and an x-ray detector configured to receive x-rays emitted from the electro-deposited chemical species and generate spectroscopic data about the chemical species electro-deposited on the first electrode,
wherein the sensor is configured such that in use the x-ray excitation beam incident on the electro-deposited chemical species on the first electrode is attenuated by no more than 60%; and
wherein the first electrode is formed of boron doped material.

2. A sensor according to claim 1, wherein the sensor is configured such that in use the x-ray excitation beam incident on the electro-deposited chemical species on the first electrode is attenuated by no more than 50%, 40%, 30%, 20%, 10%, 5%, or 1%.

3. A sensor according to claim 1, wherein the sensor is configured such that in use the x-rays emitted from the electro-deposited chemical species to the detector are attenuated by no more than 60%, 50%, 40%, 30%, 20%, 10%, 5%, or 1%.

4. A sensor according to claim 1,
wherein the x-ray source is configured to direct the x-ray excitation beam through the first electrode to the electro-deposited chemical species on the first electrode,
wherein the electrically conductive material of the first electrode is selected and formed at a thickness such that the first electrode is substantially transparent to x-rays passing through the first electrode during the x-ray fluorescence spectroscopic analysis technique, and
wherein the first electrode comprises an ohmic contact configured to allow transmittance of the x-rays through the first electrode during the x-ray fluorescence spectroscopic analysis technique,
whereby in use the first electrode does not attenuate the x-ray excitation beam incident on the electro-deposited chemical species and/or the x-rays emitted from the electro-deposited chemical species to the detector by more than any one of the previously defined limits as the x-rays pass through the first electrode.

5. A sensor according to claim 4, wherein the x-ray detector is configured to receive x-rays emitted from the electro-deposited chemical species through the first electrode.

6. A sensor according to claim 4, wherein the thickness of the first electrode through which the x-rays pass during the x-ray fluorescence spectroscopic analysis technique is no more than 100 μm, 75 μm, 50 μm, 40 μm, 30 μm, 20 μm, 10 μm, 5 μm, or 2 μm, at least across a volume of the first electrode through which the x-rays pass during the x-ray fluorescence spectroscopic analysis technique.

7. A sensor according to claim 4, wherein the first electrode has a thickness variation of no more than 50 μm, 40 μm, 30 μm, 20 μm, 10 μm, 5 μm, 1 μm, 500 nm, or 100 nm, at least across a volume of the first electrode through which the x-rays pass during the x-ray fluorescence spectroscopic analysis technique.

8. A sensor according to claim 4, wherein the ohmic contact is patterned to provide a window through which the x-rays pass during the x-ray fluorescence spectroscopic analysis technique.

9. A sensor according to claim 4, wherein the ohmic contact is configured such that the x-rays pass through at least a portion of the ohmic contact during the x-ray fluorescence spectroscopic analysis technique, the ohmic contact being formed of a material at a thickness in said portion such that the ohmic contact is substantially transparent to x-rays passing through the ohmic contact during the x-ray fluorescence spectroscopic analysis technique, whereby in use the first electrode comprising the ohmic contact does not attenuate the x-ray excitation beam incident on the electro-deposited chemical species and/or the x-rays emitted from the electro-deposited chemical species to the detector by more than any one of the previously defined amounts as the x-rays pass through the first electrode.

10. A sensor according to claim 1,
wherein the x-ray source is configured to direct the x-ray excitation beam through the solution to the electro-deposited chemical species on the first electrode, and
wherein the sensor is configured such that only a thin layer of the solution is disposed over the first electrode during the x-ray fluorescence spectroscopic analysis technique such that the thin layer of solution is substantially transparent to x-rays passing through the solution,
whereby in use the thin layer of solution does not attenuate the x-ray excitation beam incident on the electro-deposited chemical species and/or the x-rays emitted from the electro-deposited chemical species to the detector by more than any one of the previously defined limits as the x-rays pass through the thin layer of solution.

11. A sensor according to claim 10, wherein the x-ray detector is configured to receive x-rays emitted from the electro-deposited chemical species through the solution.

12. A sensor according to claim 9, wherein the thin layer of solution has a thickness of no more than 300 μm, 200 μm, 100 μm, 75 μm, 50 μm, 40 μm, 30 μm, or 20 μm, at least across a volume of the solution through which the x-rays pass during the x-ray fluorescence spectroscopic analysis technique.

13. A sensor according to claim 12, wherein the sensor comprises a solution channel having a thickness of no more than 300 μm, 200 μm, 100 μm, 75 μm, 50 μm, 40 μm, 30 μm, or 20 μm for forming the thin layer of solution disposed over the first electrode, the solution channel comprising an x-ray window opposite the first electrode for transmitting x-rays through the solution channel to chemical species electro-deposited on the first electrode.

14. A sensor according to claim 1,
wherein the x-ray source is configured to direct the x-ray excitation beam onto the electro-deposited chemical species on the first electrode through a solution pathway, and
wherein the sensor is configured such that a solution of interest is disposed within the solution pathway to perform electro-deposition and then removed from the solution pathway to perform the x-ray fluorescence spectroscopic analysis technique.

15. A sensor according to claim 14, wherein the x-ray detector is configured to receive x-rays emitted from the electro-deposited chemical species through the solution pathway.

16-18. (canceled)

19. A sensor according to claim 1, wherein the electrical controller is configured to change the applied potential to strip or otherwise remove the electro-deposited chemical species from the first electrode.

20. A sensor according to claim 19, wherein the electrical controller is configured to measure an electric current during stripping of the electro-deposited chemical species thereby generating voltammetry data for the electro-deposited chemical species, the first electrode functioning as an electrochemical sensing electrode and the second electrode functioning as a reference electrode.

21. A sensor according to claim 20, comprising a processor configured to use the spectroscopic data and the voltammetry data or associated electrochemical data to determine the type and quantity of chemical species in the solution.
